(19) United States
(12) Patent Application Publication
(10) Pub. No.: US 2014/0363228 A1
(43) Pub. Date: Dec. 11, 2014

(54) LADDER RETAINING BRACKET

(71) Applicant: Constantine Vassilakos, Holmdel, NJ (US)

(72) Inventor: Constantine Vassilakos, Holmdel, NJ (US)

(21) Appl. No.: 14/298,519

(22) Filed: Jun. 6, 2014

Related U.S. Application Data
(60) Provisional application No. 61/833,299, filed on Jun. 10, 2013.

(51) Int. Cl. E06C 7/50

(52) U.S. Cl. CPC E06C 7/50
USPC 403/403; 29/525.01

(57) ABSTRACT

Ladder retaining brackets to attach two ladders together is provided. The ladder retaining brackets may include a base plate and at least two retainer plates forming channels within. The rails of a first ladder and a second ladder are secured within the channels of two retaining brackets. Therefore, the present invention may be used to attach to extendable ladders together to form one extendable A frame ladder.

### CROSS-REFERENCE TO RELATED APPLICATION

This application claims the benefit of priority of U.S. provisional application No. 61/833,299, filed Jun. 10, 2013, the contents of which are herein incorporated by reference.

### BACKGROUND OF THE INVENTION

The present invention relates to ladders and, more particularly, to a ladder retaining bracket formed to secure two extendable ladders together.

The Stepladder or A frame ladder is a self-supporting portable ladder that is non-adjustable in length, with flat rungs and a hinged design for ease of storage. The Stepladder may be used by one person. The Extension Ladder is a non-self-supporting portable ladder that is adjustable in length. The Extension ladder consists of two or more sections that travel in guides or brackets arranged so as to permit length adjustment. Stepladders are more stable and may be used for different purposes when compared to the extension ladder. However, as mentioned above, stepladders cannot be extended in length.

As can be seen, there is a need for a bracket that attaches to extension ladders together to form an extendable A frame ladder.

### SUMMARY OF THE INVENTION

In one aspect of the present invention, a ladder retaining bracket comprises: a base plate comprising an inside surface, an outside surface, a first side, a second side, a top end and a bottom end; at least one first retainer plate attached to the inside surface on the first side of the base plate forming a first channel in between the at least one first retainer plate and the base plate; at least one second retainer plate attached to the inside surface on the second side of the base plate forming a second channel in between the at least one second retainer plate and the base plate; wherein the first channel and the second channel are disposed an angle relative to one another, wherein the first channel and the second channel are sized to receive ends of side rails of a ladder and are configured to retain the ends of the side rails within.

In another aspect of the present invention, a method of attaching two ladders together comprises: providing a ladder retaining bracket comprising: a base plate; and two retainer plates attached to the base plate forming a first channel and a second channel; securing a first end of a first side rail of a first ladder into the first channel; and securing a first end of a first side rail of a second ladder in the second channel.

These and other features, aspects and advantages of the present invention will become better understood with reference to the following drawings, description and claims.

### BRIEF DESCRIPTION OF THE DRAWINGS

FIG. 1 is a front perspective view of an embodiment of the present invention in use;

FIG. 2 is a perspective view of an embodiment of the present invention;

FIG. 3 is a cross-sectional view taken on line 3-3 of FIG. 2;

FIG. 4 is a front elevation view of an embodiment of the present invention;

FIG. 5 is a rear elevation view of an embodiment of the present invention; and

FIG. 6 is a side elevation view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides ladder retaining brackets that attach two extension ladders at their peaks creating an adjustable A Frame Ladder. There may be two main plates which attach to the exterior side of the fly rail of an extension ladder. The fly rail sits within the channel and is secured via the retainer plate above and below the top rung of the ladder. When two ladders are attached in the channels via the retainer plates the individual ladders create a single adjustable A Frame ladder. The two ladders may now be used for entirely different purposes.

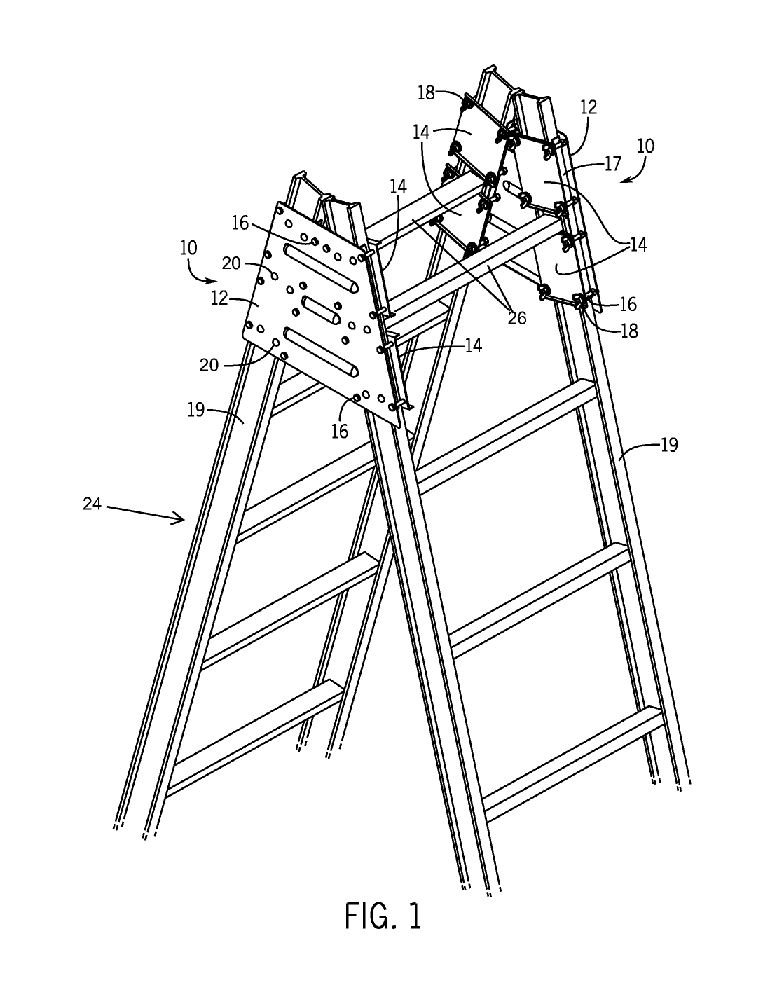

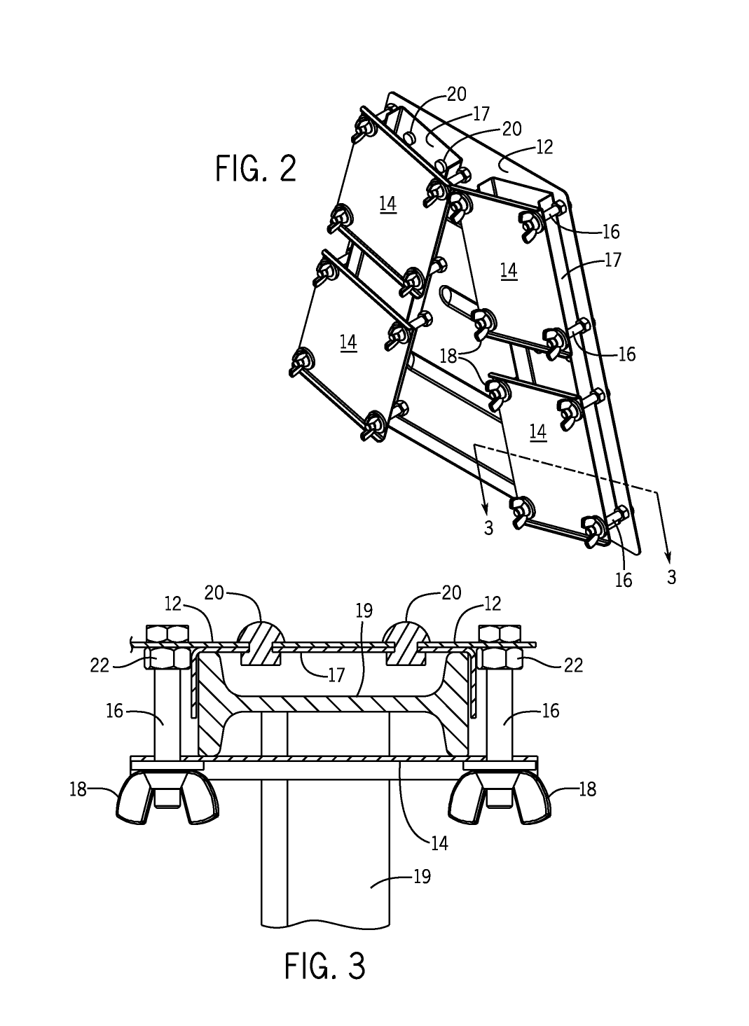

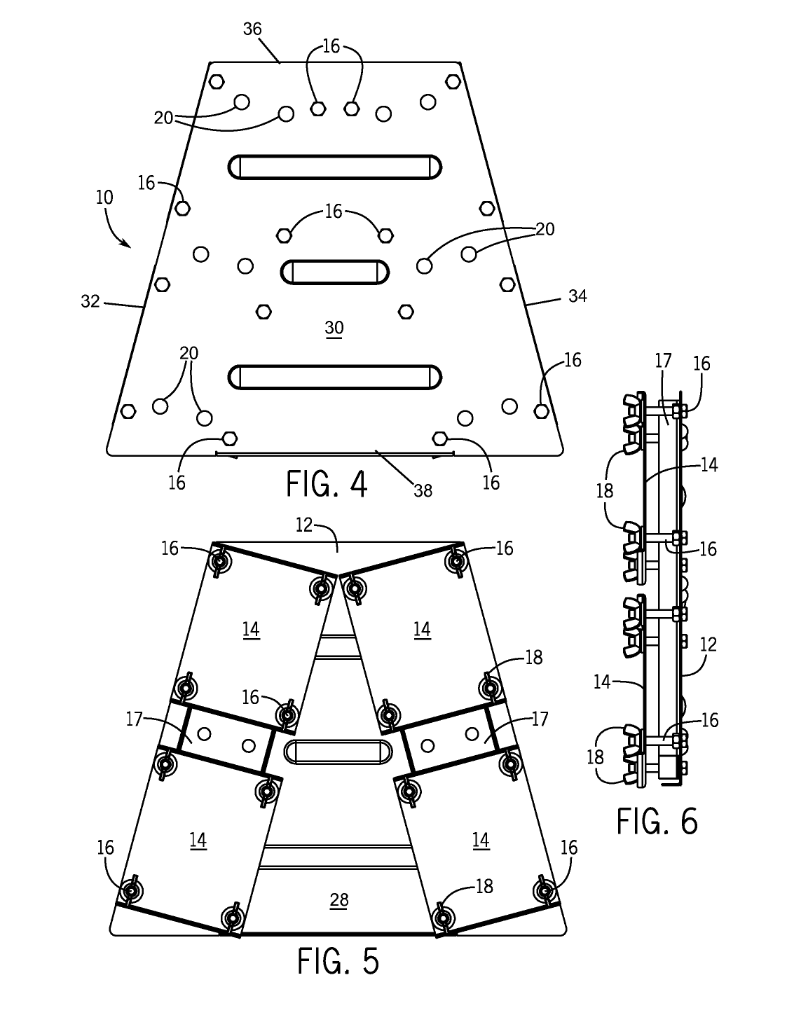

Referring to FIGS. 1 through 6, the present invention includes ladder retaining brackets 10. A ladder retaining bracket 10 may include a base plate 12 and retainer plates 14. The base plate 12 may include an inside surface 28, an outside surface 30, a first side 32, a second side 34, a top end 36 and a bottom end 38. At least one first retainer plate 14 may be attached to the inside surface 28 on the first side 32 of the base plate 12 forming a first channel in between. At least one second retainer plate 14 may be attached to the inside surface 28 on the second side 34 of the base plate 12 forming a second channel in between. The first channel and the second channel are disposed an angle relative to one another, and are sized to receive and configured to retain ends of side rails 19 of a ladder 24 within. Two ladder retaining brackets 10 may be used to secure two extendable ladders 24 together.

In certain embodiments, the present invention may include four retainer plates 14. As illustrated in the Figures, there may be a retainer plate 14 attached to the base plate 12 near the first side 32 and the top end 36 and a retainer plate 14 attached to the base plate 12 near the first side 32 and the bottom end 38. The two retainer plates 14 on the first side 32 have aligning channels running in a substantially vertical position. There may be a retainer plate 14 attached to the base plate 12 near the second side 34 and the top end 36, and a retainer plate 14 attached to the base plate 12 near the second side 34 and the bottom end 38. The two retaining plates 14 on the second side 34 have aligning channels running in a substantially vertical position. The channels formed by the four retainer plates 14 may form a V-shape. The retainer plates 14 on the first side and the second side may have gaps in between sized to fit the top rung 26 of the ladder 24 within.

The rails 19 of the ladder 24 may be secured within the channels by various means known in the art. For example, a top end of the channel may be at least partially blocked off by a flange. In certain embodiments, the distance between the retainer plates 14 and the base plate 12 may be adjustable. In such embodiments, the retainer plates 14 may be attached to the inner surface of the base plate by a plurality of threaded bolts 16 and a plurality of threaded wing nuts 18. Jam nuts 22 may be used to secure the ends of the threaded bolts 16 to the base plate 12. In such embodiments, a rail 19 of the ladder 24 may be placed in between the base plate 12 and a retainer plate 14. The threaded wing nuts 18 may then be tightened, pressing the retainer plate 14 against the rail 19, and thereby securing the ladder retaining bracket 10 to the ladder 24.

The present invention may further include U-brackets 17 attached to the inner surface of the base plate 12 in between the retainer plates 14 and the base plate 12. The U-brackets 17 may form the channels in between the base plate 12 and the retainer plate 14, and may receive the rails 19 of the ladder 24 within. In certain embodiments, the present invention may include a first U-bracket attached to the base plate 12 running from the top end 36 to the bottom end 38 on the first side 32. The two retaining plates 14 on the first side may cover the first U-shaped bracket 17. The present invention may include a second U-bracket attached to the base plate 12 running from the top end 36 to the bottom end 38 on the second side 34. The two retaining plates 14 on the second side 34 may cover the second U-shaped bracket 17. The U-shaped brackets 17 may be attached to the base plate 12 by rivets 20. The U-bracket 17 and retainer plates 14 may be bent at the ends for additional strength.

A method of attaching two ladders 19 together may include the following. Place a first side rail 19 of a first ladder 24 within a channel formed by a first U-bracket 17 of a first ladder retaining bracket 10. Place a first side rail 19 of a second ladder 24 within a channel formed by a second U-bracket 17 of the first ladder retaining bracket 10. Place a second side rail 19 of the first ladder 24 within a channel formed by a first U-bracket 17 of a second ladder retaining bracket 10. Place a second side rail 19 of the second ladder 24 within a channel formed by the second U-bracket 17 of the second ladder retaining bracket 10. Provide eight retainer plates 14 each including holes. The first ladder retaining bracket 10 and the second ladder retaining bracket 10 may both include threaded bolts 16 protruding from the inside surface 28 of the base plate 12 on either side of the U-brackets 17. Align the holes of the retainer plates 14 with the threaded bolts 16 of the ladder retaining brackets 10 and attach four retainer plates 14 to each ladder retaining bracket 10. Screw a threaded wing nut 18 to each of the threaded bolts 16, thereby pressing the retainer plates 14 against the rails 19 within the channels. Using the two ladder retaining brackets 10, a user may secure fly section rails of two different ladders 24, thereby creating an extendable and adjustable A-frame ladder. The components may be made of 16 gauge steel which is cut to specific sizes.

It should be understood, of course, that the foregoing relates to exemplary embodiments of the invention and that modifications may be made without departing from the spirit and scope of the invention as set forth in the following claims.

What is claimed is:

1. A ladder retaining bracket comprising:
a base plate comprising an inside surface, an outside surface, a first side, a second side, a top end and a bottom end;
at least one first retainer plate attached to the inside surface on the first side of the base plate forming a first channel in between the at least one first retainer plate and the base plate;
at least one second retainer plate attached to the inside surface on the second side of the base plate forming a second channel in between the at least one second retainer plate and the base plate;
wherein the first channel and the second channel are disposed an angle relative to one another,
wherein the first channel and the second channel are sized to receive ends of side rails of a ladder and are configured to retain the ends of the side rails within.

2. The ladder retaining bracket of claim 1, comprising two ladder retaining brackets.

3. The ladder retaining bracket of claim 1, wherein the at least one first retainer plate comprises two first retainer plates aligning to form the first channel, wherein a top rung of a ladder is formed to fit in between the two first retainer plates.

4. The ladder retaining bracket of claim 3, wherein the at least one second retainer plate comprises two second retainer plates aligning to form the second channel, wherein a top rung of a ladder is formed to fit in between the two second retainer plates.

5. The ladder retaining bracket of claim 1, further comprising a first U-bracket forming the first channel and attached to the inside surface of the base plate, in between the at least one first retainer plate and the base plate, and a second U-bracket forming the second channel and attached to the inside surface of the base plate, in between the at least one second retainer plate and the base plate.

6. The ladder retaining bracket of claim 1, wherein the distance between the retainer plates and the base plate is adjustable.

7. The ladder retaining bracket of claim 7, wherein the retainer plates are attached the base plates by a plurality of threaded bolts and a plurality of threaded wing nuts.

8. A method of attaching two ladders together comprising:
providing a ladder retaining bracket comprising:
a base plate; and
two retainer plates attached to the base plate forming a first channel and a second channel;
securing a first end of a first side rail of a first ladder into the first channel; and
securing a first end of a first side rail of a second ladder in the second channel.

9. The method of claim 8, further comprising attaching a second ladder retaining bracket to opposite side rails of the first ladder and the second ladder.

10. The method of claim 8, wherein the two retainer plates are attached to the base plate by a plurality of threaded bolts and a plurality of threaded wing nuts.
